(19) United States
(12) Patent Application Publication
(10) Pub. No.: US 2013/0115539 A1
(43) Pub. Date: May 9, 2013

(54) FLUID FLOW ASSEMBLIES FOR, AND IN, FUEL CELL STACKS

(71) Applicant: Eric J. O'Brien, Tolland, CT (US)

(72) Inventor: Eric J. O'Brien, Tolland, CT (US)

(21) Appl. No.: 12/998,547

(22) PCT Filed: Jan. 5, 2009
(86) PCT No.: PCT/US09/00020

§ 371 Date: Apr. 29, 2011

(51) Int. Cl. H01M 8/04

(52) U.S. Cl. CPC H01M 8/04089; H01M 8/04029
USPC 429/434; 429/457

(57) ABSTRACT

Fuel cells and related assemblies involving directionally independent channels are provided. In this regard, a representative fuel cell stack (100) includes: a first fuel cell (102) having channels (116, 216, 316; 156, 256, 356) associated with an anode; and a second fuel cell (101), located adjacent the first fuel cell, having channels (128, 228, 328; 158, 258, 358) associated with a cathode, the channels associated with the cathode exhibiting directional independence (344) with respect to the channels associated with the anode. A ribbed, three plate (111, 211, 311; 121, 221, 321; 150, 250, 350), assembly (152, 252) may provide fuel reactant and anode coolant flow channels having a first parallel orientation (342) and oxidant reactant and cathode coolant flow channels having a second parallel orientation independent of and different (344) than the first orientation.

### BACKGROUND

The disclosure relates generally to fuel cells, and more particularly to fluid flow assemblies for and/or in, fuel cell stacks.

Fuel cells, such as Proton Exchange Membrane (PEM) fuel cells, oftentimes are arranged in assemblies known as fuel cell stacks. In such a fuel cell stack, the fuel cells are oriented adjacent to each other. In particular, this orientation involves the cathode of one of the fuel cells being located adjacent to the anode of a next of the fuel cells. In operation, fuel reactant (e.g., hydrogen) flows through channels at the anodes and oxidant reactant (e.g., air) flows through channels at the cathodes. A coolant (e.g. water) may also flow in the fuel cell in proximity with the anode and cathode reactant flow channels.

Conventionally, two plates (e.g., stamped plates) can be positioned between two adjacent fuel cells to form the anode channels of one of the fuel cells and the cathode channels of the other. The channels serve to deliver fluid reactant to the respective anodes and cathodes via an array of flow channels collectively called flow fields, and thus the plates may be termed, individually or collectively, fluid flow field plates or, simply, flow field plates. One such example is disclosed in U.S. Pat. No. 5,981,098 to N. G. Vitale for ‘Fluid flow Plate for Decreased Density of Fuel Cell Assembly”. Specifically, when the flow field plates are positioned so that one overlies the other, the anode channels are formed on the outside of one of the plates, the cathode channels are formed on the outside of the other of the plates. In some embodiments, coolant channels are formed between the plates. In such configurations, and assuming the channels are formed by stamping the plates, the anode channels, cathode channels, and coolant channels if present, would be generally aligned, or matched.

However, such matching of channels, and thus flow paths, may not be desirable throughout the total extent of the channels. This is particularly the case where, as in most systems, the reactant flow fields are not only straight flow channels, but include turns to provide multiple passes across the plate throughout the zone or region termed the “active area”. The “active area” is that in which the well-known electrochemical reaction of the fuel cells takes place. In the region(s) or sub-zone(s) of the plates in which the anode and cathode flow fields may not be parallel, as for instance where turns in the flow of a reactant occur, it is desirable to afford the coolant flow fields on the back of each plate a directional independence of flow. To this end and referring briefly to FIGS. 1, 2, and 3, a prior configuration has used back-to-back, typically stamped, flow field plates 11 and 21 to form a flow field assembly 10 adjacent to unified electrode assemblies (UEA) 9. The plates 11 and 21 having normally continuous ridges, or ribs, 14 and valleys, or channels, 15, with the valleys serving as reactant channels 16 and 28 on their outer surfaces and the inner surfaces 18 of the ridges forming the common coolant channels 57 as the valleys 15 of flow field plates 11 and 21 are in back-to-back contact to form flow field assembly 10.

In order to accommodate the need for some independence of the flow direction of the reactants and the coolant in the turn region(s) 60 (shown in circular broken line), those back-to-back flow field plates 11 and 21 have been provided with a so-called mid-plane region 62 (shown in rectangular broken line) at the channel turn region(s) 60 of those plates. In this regard, in the mid-plane region(s) 62, the channeled structure of each of the flow field plates 11 and 21 transitions to a “mid-plane” configuration having an array of protrusions 64 and 64′ (in FIG. 3) about which fluid can turn while flowing. Oftentimes, the fluid (reactant or coolant) flows through a set of defined channels, turns in a mid-plane region not having defined channels, and then flows through another set of defined channels. The mid-plane region 62 of each plate 11 and 21 is comprised of a middle plane, typically midway between the tops of the ridges and bottoms of the valleys, having bosses or nubbins or protrusions 64 and 64′ projecting inward and outward, respectively. It should be noted that FIG. 3 is not to scale, with the size of the several components being exaggerated for clarity of understanding. The inwardly-projecting bosses 64 on one flow field plate contact corresponding bosses 64 on the opposed flow field plate, as shown in limited detail in FIG. 3. Similarly, the outwardly-projecting bosses 64′ contact the respective adjacent UEA's 9. The bossed, or embossed, mid-plane region 62 is thus a region of generally-open chambers for omni-directional flow of reactants and coolant, and is interrupted only by the columns formed by the bosses 64 and 64′. It will be noted that the active region or active zone 66 of the assembly formed by flow field plates 11 and 21 includes the channel turn regions 60, and thus also includes the mid-plane region 62.

### SUMMARY

Fuel cells and related assemblies involving directionally independent channels are provided. Performance and/or durability of a fuel cell stack are improved by using only traditional fluid flow channels in the active area. In this regard, an exemplary embodiment of a fuel cell stack comprises: a first fuel cell having channels associated with an anode; and a second fuel cell, located adjacent the first fuel cell, having channels associated with a cathode, the channels associated with the cathode exhibiting directional independence with respect to the channels associated with the anode. The channels may include reactant channels and coolant channels.

An exemplary embodiment of an assembly for use in a fuel cell stack comprises: a first plate, a second plate and a third plate, with the third plate being positioned between the first plate and the second plate, the third plate having an anode side facing the first plate and an opposing cathode side facing the second plate; the first plate defining fuel reactant channels on a side of the first plate facing away from the third plate and anode coolant channels on a side of the first plate facing the third plate; and the second plate defining oxidant reactant channels on a side of the second plate facing away from the third plate and cathode coolant channels on a side of the second plate facing the third plate. The first, second, and third plates have a mutually coincident active area. At least the first and second plates are typically stamped to form at least the channels therein.

In another embodiment having first, second and third plates, at least the first and second plates further include non-active manifold regions having associated mid-plane regions to provide fluid communication between respective manifolds and the reactant and coolant channels. The mid-plane regions are limited to substantially only non-active, manifold portions of the associated fluid flow plates, to thereby relatively improve the performance and/or durability of the fuel cell stack.

Other systems, methods, features and/or advantages of this disclosure will be or may become apparent to one with skill in the art upon examination of the following drawings and detailed description. It is intended that all such additional systems, methods, features and/or advantages be included within this description and be within the scope of the present disclosure.

### BRIEF DESCRIPTION OF THE DRAWINGS

Many aspects of the disclosure can be better understood with reference to the following drawings. The components in the drawings are not necessarily to scale. Moreover, in the drawings, like reference numerals designate corresponding parts in the several views.

FIG. 1 is a schematic diagram depicting a portion of a fuel cell having a pair of fluid flow plates providing reactant and coolant channels in accordance with the prior art;

FIG. 2 is a schematic diagram plan view of the stacked plates of FIG. 1 in accordance with the prior art, identifying the active region of the plates and a 3-pass path for the reactants, including reactant turn zones;

FIG. 3 is an elevational, sectional view taken at line 3-3 of FIG. 2, illustrating the plates defining a mid-plane region in the area of the reactant turn zones;

FIG. 4 is a schematic diagram of a portion of a fuel cell stack depicting components of a fuel cell having a pair of back-to-back fluid flow plates separated by an intermediate plate, assembled to form a fluid flow field plate in accordance with the present disclosure;

FIG. 5 is an exploded, schematic view of a portion of the fuel cell stack of FIG. 4, showing detail of the fluid flow plates and intermediate separator plate;

FIG. 6 is a schematic diagram of a portion of a fluid flow field plate illustrating directional independence of reactant and coolant flow channels in accordance with the present disclosure;

FIG. 7 is a schematic diagram plan view depicting a portion of another exemplary embodiment of a fuel cell, showing detail of reactant flow through associated channels, turns, and manifolds, and having mid-plane regions only in the non-active regions;

FIG. 8 is an enlarged perspective view, partly broken away, of the encircled portion of the fuel cell of FIG. 7, depicting mid-planing therein; and

FIG. 9 is a sectional view taken along lines 9-9 of FIGS. 7 and 8, of a mid-planed portion of the fuel cell.

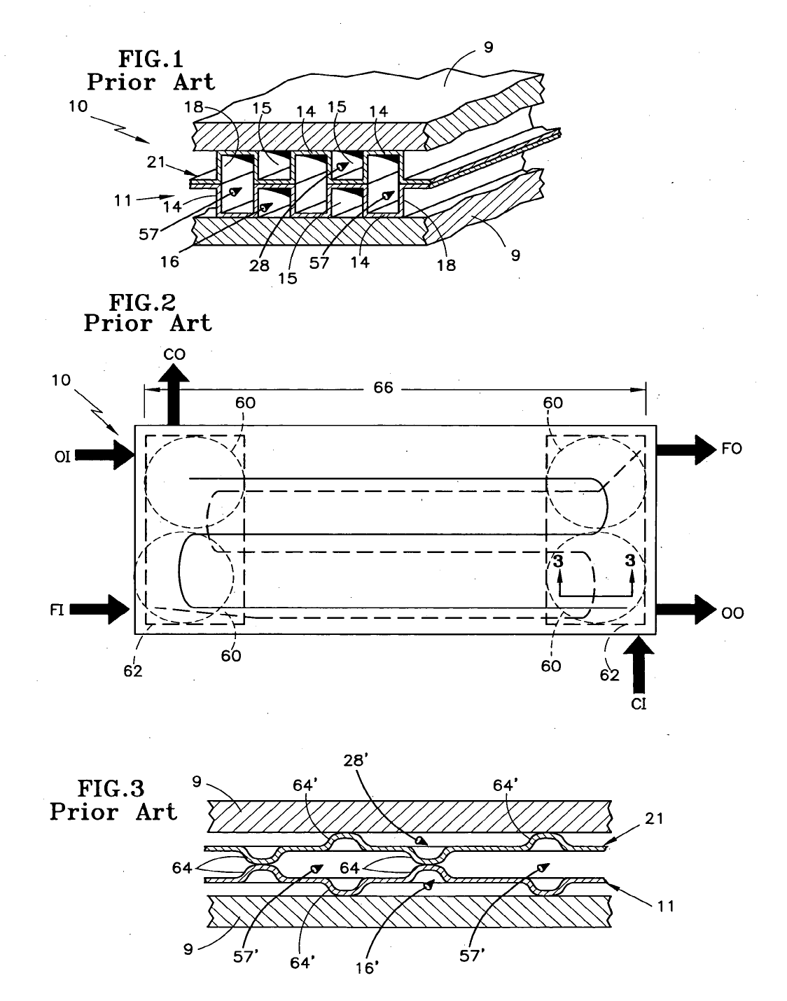

### DETAILED DESCRIPTION

Fuel cells and related assemblies involving directionally independent channels are provided, exemplary embodiments of which will be described in detail. In this regard, some embodiments involve the use of three plates (e.g., stamped plates) to create reactant channels and coolant channels of adjacent fuel cells. The use of three plates enables the orientation of the fuel channels to be decoupled from the orientation of the oxidant channels, thus providing directional independence of the reactant channels. Additionally, in some embodiments, the coolant channels exhibit directional independence, in that a first set of the coolant channels turns with the fuel channels and a second set of the coolant channels turns with the oxidant channels. Further, such use of directionally independent channels enables mid-plane regions to be eliminated from the active regions of the fluid flow plates, and their use confined to the inactive inlet and/or outlet regions adjacent to the manifolds.

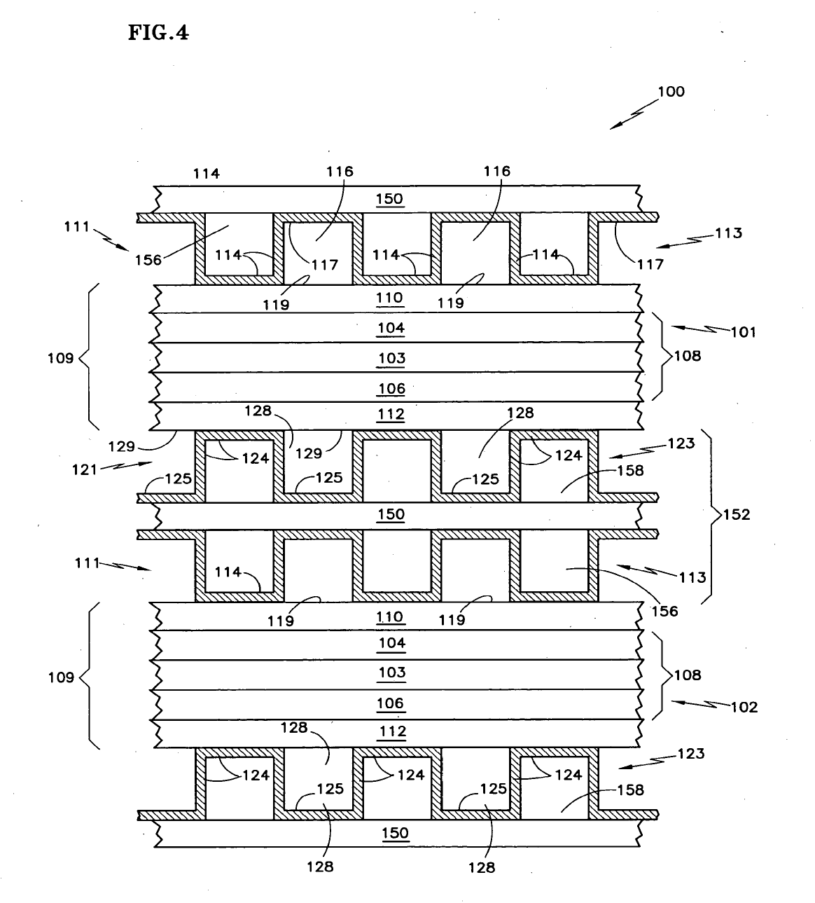

An exemplary embodiment of a fuel cell stack is partially depicted in the schematic diagram of FIG. 4. In FIG. 4, two fuel cells of fuel cell stack 100 are shown (i.e., fuel cells 101, 102). In this embodiment, each of the fuel cells is a Proton Exchange Membrane (PEM) fuel cell. Specifically, fuel cell 101 incorporates a membrane 103 that is oriented between catalyst layers 104, 106. The catalyst layers and membrane define a membrane electrode assembly (MEA) 108. The membrane electrode assembly is positioned between opposing substrates 110, 112 that function as gas diffusion layers (GDLs), thereby forming a Unitized Electrode Assembly (UEA) 109.

Adjacent to substrate 110 and opposing the membrane electrode assembly is an anode flow field plate structure 111 that serves as an electrically conductive electrode and includes an array 113 that serves as a fuel reactant flow field. The anode flow field plate structure 111 is formed typically by a stamping operation that defines an array of alternating ribs 114 and valleys, or channels, 116. Channels 116 are defined between the ribs 114. By way of example, each channel 116 of array 113 is defined by a pair of adjacent ribs 114, a corresponding channel wall 117 of the anode flow field plate structure 111, and a corresponding portion 119 of substrate 110. Notably, the channels of array 113 are anode channels, with the reactant or fuel of this embodiment that is provided to the anode channels being hydrogen or a hydrogen-rich gas.

Adjacent to substrate 112 and opposing the membrane electrode assembly is a cathode flow field plate structure 121 that serves as an electrically conductive electrode and includes an array 123 that serves as an oxidant reactant flow field. The cathode flow field plate structure 121 is formed typically by a stamping operation that defines an array of alternating ribs 124 and valleys, or channels, 128. Channels 128 are defined between the ribs 124. By way of example, each channel 128 of array 123 is defined by a pair of adjacent ribs 124, a corresponding channel wall 125 of the cathode flow field plate structure 121, and a corresponding portion 129 of substrate 112. In this embodiment, the channels 128 of array 123 are cathode channels with the reactant provided to the cathode channels being an oxidant, such as air.

Fuel cell 102 is positioned adjacent to fuel cell 101 and is structurally the same as fuel cell 101. Accordingly, the various elements of fuel cell 102 have the same reference numbers as their identical counterparts in fuel cell 101.

Important in the present disclosure is the provision of coolant channels formed by and in association with the anode flow field plate structure 111 and the cathode flow field plate structure 121, and the further provision of a separator member, or plate, intermediate the anode flow field plate structure 111 and the cathode flow field plate structure 121 to enable the fluid flow channels of the anode flow field plate structure 111 to exhibit or possess, directional independence with respect to the fluid flow channels of the cathode flow field plate structure 121. In this regard, a separator plate 150, typically of non-porous, electrically-conductive material, is located intermediate the anode flow field plate structure 111 and the cathode flow field plate structure 121 in mutual liquid sealing engagement with each, thereby forming a three-plate, fluid flow field assembly 152. The coolant is typically a liquid, such as water. The anode flow field plate structure 111 and the cathode flow field plate structure 121 are each stamped plates, typically of a metal alloy, for example stainless steel, and having a thickness of the order of 0.1 mm. The separator plate 150 may be similar to the anode flow field plate structure 111 and the cathode flow field plate structure 121, but may be flat throughout and need not be stamped.

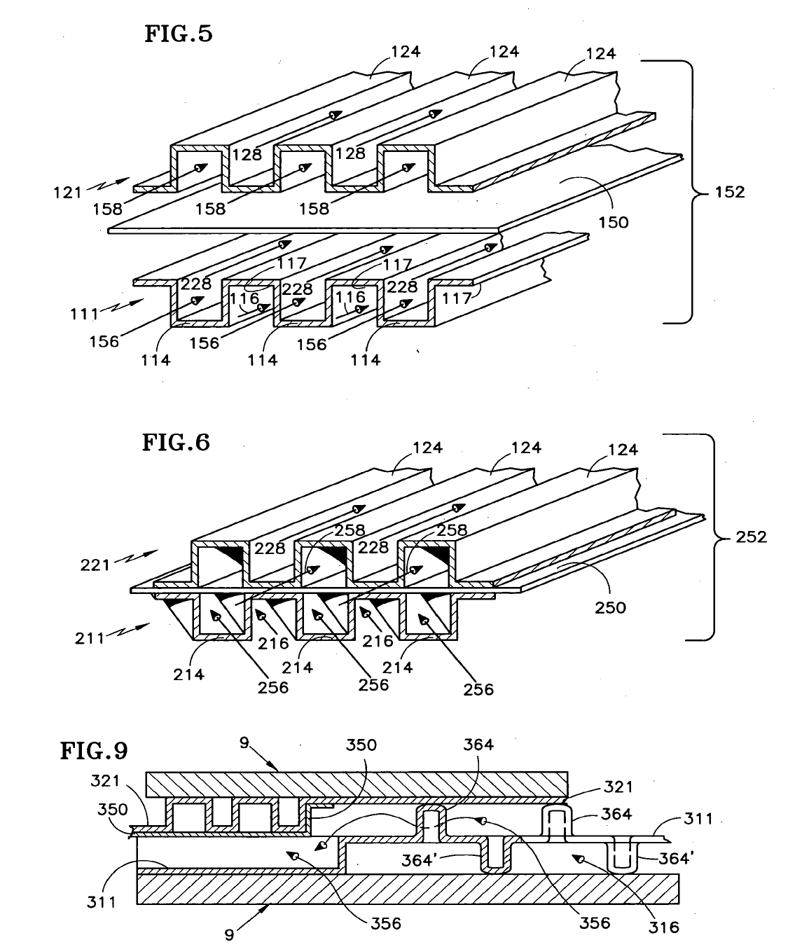

Referring additionally to FIG. 5, the three-plate fluid flow field assembly 152 is shown in greater detail in exploded form. As mentioned above, fuel reactant channels 116 are defined by the valleys between ribs 114 in the anode flow field plate structure 111, and oxidant reactant channels 128 are defined by the valleys between ribs 124 in the cathode flow field plate structure 121. Moreover, plate 150, which is located between plates 111 and 121, is generally planar and contacts the inwardly facing sides of plates 111 and 121 to define coolant channels. Notably, in this embodiment, the coolant channels are located within the confines of the ribs. For instance, a coolant channel 156 is defined between rib 114 and plate 150, and a coolant channel 158 is defined between rib 124 and plate 150. Notably, in this embodiment, the coolant channels are located within the confines of the ribs.

By locating plate 150 between plates 111 and 121, the set of reactant and coolant channels located on one side of plate 150 can be oriented directionally independent of the set of reactant and coolant channels located on the other side of plate 150 without disturbing the coolant flow or flow distribution. Such a configuration is depicted schematically in FIG. 6, which may be simply a different region or portion of the channels defined by the anode flow field plate structure 111 and the cathode flow field plate structure 121 of the embodiment of FIGS. 4 and 5, as for example in the turn region, or it may represent a separate embodiment. For the foregoing reason, the elements of FIG. 6 have been numbered analogously to those elements of FIGS. 4 and 5, but the “hundreds” digit is a “2” rather than a “1”. Thus, the three-plate, fluid flow field assembly 252 includes an anode flow field plate structure 211, a cathode flow field plate structure 221, and a separator plate 250 there between in liquid sealing engagement therewith. The anode flow field plate structure 211 includes spaced ribs 214 between which are fuel reactant flow channels 216, and within which, in combination with the separator plate 250, are anode coolant channels 256. Similarly, the cathode flow field plate structure 221 includes spaced ribs 224 between which are oxidant reactant flow channels 228, and within which, in combination with the separator plate 250, are cathode coolant channels 258.

Referring to FIG. 6, it is seen that although the reactant flow channels and associated coolant channels for respective ones of the reactants or respective ones of the anode and cathode flow field plates, extend parallel to one another, they may relatively differ in directional orientation as between the different reactants. Stated another way, while the reactant flow channels and associated coolant channels for one of the reactants (or one of the flow field plates) extend in one direction, the reactant flow channels and associated coolant channels for the other of the reactants (or other of the flow field plates) may extend in a different direction. In this way, turns in the flow path for one reactant and associated coolant flow may be made independently of the flow paths for the other reactant and associated coolant. This independence of flow path directions allows for the avoidance or elimination of a mid-plane structure in the active turn regions, and accordingly reduces any adverse impact of a mid-plane structure in the active region of a fuel cell.

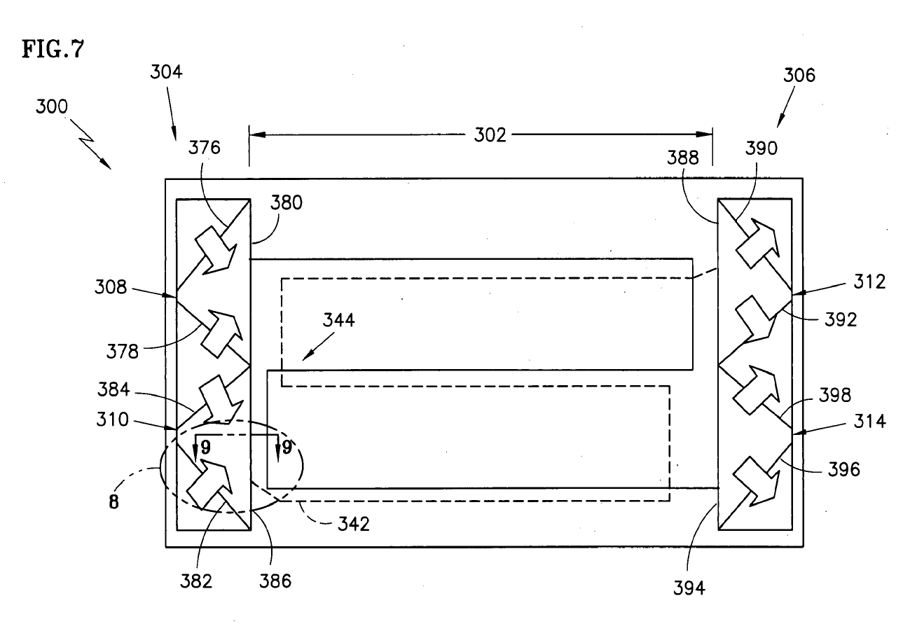

As shown in FIG. 7, assembly 300, which is part of fuel cell stack 100 or a similar stack and may be duplicative of or merely representative of assemblies 152 and/or 252, includes an active region 302, and an inlet manifold region 304 and an outlet manifold region 306 located at respective ends of the active region. The inlet and outlet manifold regions, 304 and 306 respectively, are beyond the active region 302 where the electrochemical reaction occurs, and thus may be considered non-active regions. Inlet manifold region 304 incorporates two inlets 308, 310, and outlet manifold region 306 incorporates two outlets 312, 314. In particular, inlet 308 includes an oxidant edge 376, a coolant edge 378 and a fluid transition edge 380. Inlet 310 includes a fuel edge 382, a coolant edge 384 and a fluid transition edge 386. Outlet 312 includes a fluid transition edge 388, a fuel edge 390 and a coolant edge 392. Outlet 314 includes a fluid transition edge 394, an oxidant edge 396 and a coolant edge 398. Of course, in other embodiments the positions of the inlet and outlet manifold regions may differ, as well as the positioning of the various fluid flow edges mentioned above. In this embodiment, the inlets and outlets 304 and 306 each incorporate mid-plane regions having mid-planing similar to, but not identical to, the mid-planing of region 62 of FIG. 2 (depicted in detail in FIG. 3), in order to direct fluids selectively to or from the appropriate channels defined by the plates that form the active region 302. A portion of the inlet 310 in the inlet manifold region 304 is broken away to reveal bosses, or protuberances, 364 and 364′ located in and forming part of the mid-planing in that region. Much like the embodiment of FIG. 6, and referring collectively to FIGS. 7, 8, and 9, multiple plates form the active region 302, with the flow field assembly typically comprising three plates including an anode flow field plate structure 311, a cathode flow field plate structure 321, and a separator plate 350.

As an example of multi-pass flow, two discrete fluid paths are depicted in FIG. 7. Specifically, the solid line represents the flow of oxidant through a cathode channel, and the dashed line represents the flow of fuel through an anode channel. Corresponding coolant channels run and turn with the respective cathode and anode channels, although not separately depicted in FIG. 7.

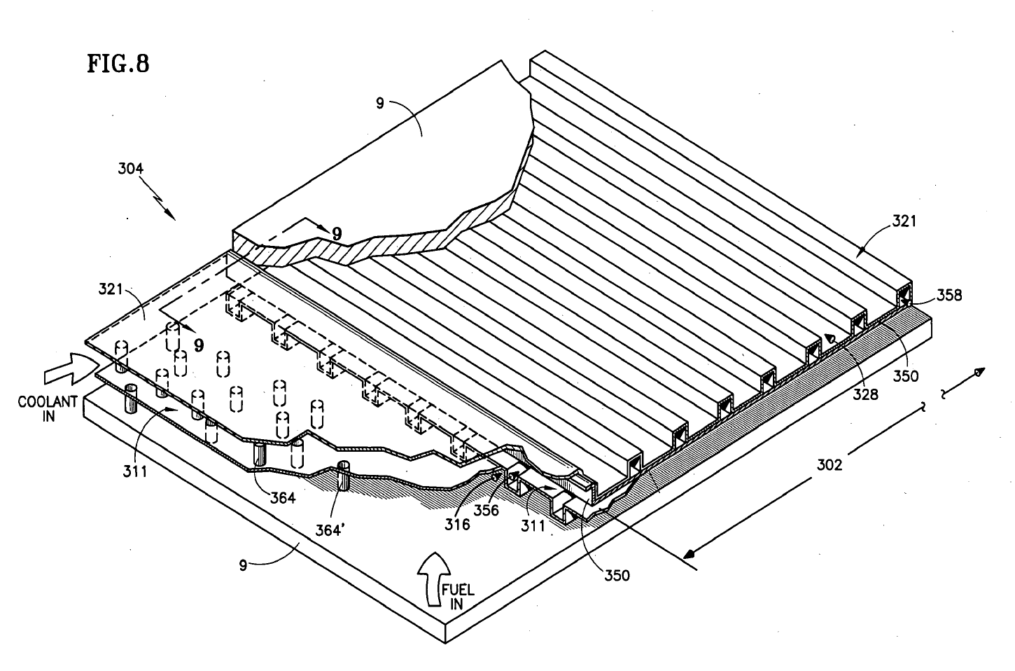

Referring generally to FIG. 7 and more particularly to FIGS. 8 and 9, there is provided a detailed illustration of the mid-planing that occurs in the inlet and outlet manifold regions 304 and 306 generally, with particular example shown of the fuel and coolant inlet 310 of inlet manifold region 304. The separator plate 350 terminates at the end of the active region 302 and includes a closure tab sealed to the cathode flow field plate structure 321 to isolate the oxidant channels 328 and coolant channels 358 from the inlet 310 mid-plane region. The remainder of the cathode flow field plate structure 321 in this inlet 310 is flat and not channeled. The anode flow field plate structure 311 in this location provides the mid-plane structure, which is formed by a transition from the normal channeling in that plate to a continuation of the plate at the upper extent of its ridges approximately mid-way (mid-plane) between the anode and cathode UEA's 9. At that mid-plane between the UEA's, the plate 111 is nominally flat and is provided with bosses, or nubbins or protrusions, 364 and 364′. The bosses 364 extend toward, and engage, support, and space the cathode plate 321 and/or cathode UEA, and the bosses 364′ extend toward, and engage, support, and space the anode UEA. The bosses 364 and 364′ are formed by stamping and although appearing exaggerated for clarity in the several Figures, are not of large displacement, being only sufficient to collectively span the distance between the anode UEA and the cathode plate 321 and or its UEA. In this way, omnidirectional flow paths are provided for fuel and some coolant. The omnidirectional flow path for fuel is represented by flow arrow 316, and that for some of the coolant is represented by flow arrow 356, the 2-digit suffixes being in keeping with prior Figures.

In operation, oxidant is provided to oxidant edge 376 of inlet 308 and coolant is provided to coolant edge 378. The mid-planed configuration of inlet 308 directs the oxidant from the oxidant edge to cathode channels (e.g., channel 328) located at the fluid transition edge 380, while directing coolant from the coolant edge to coolant channels 358, which run adjacent to the cathode channels 328 on the back of the cathode plate. Similarly, fuel is provided to fuel edge 382 of inlet 310 and coolant is provided to coolant edge 384. The mid-planed configuration of inlet 310 directs the fuel from the fuel edge to anode channels (e.g., channel 316) located at the fluid transition edge 386, while directing coolant from the coolant edge to coolant channels 356, which run adjacent to the anode channels on the back of the anode plate.

After flowing through the respective channels, outlet 312 receives the fuel and associated coolant at fluid transition edge 388 and directs the fluids via a mid-plane region to separate sides, or edges. Specifically, fuel is directed out through fuel edge 390 and coolant is directed out through coolant edge 392. Similarly, outlet 314 receives the oxidant and associated coolant at fluid transition edge 394, with the oxidant being directed out through oxidant edge 396 and coolant being directed out through coolant edge 398.

As shown in FIG. 7, the anode and cathode channels exhibit directional independence and, in this embodiment, are parallel along a first portion (e.g., at location 342), and cross each other at other locations within the active region (e.g., at location 344) without the use of a mid-plane region at those locations. Note also that since coolant channels are aligned with both the cathode and the anode channels, the coolant channels associated with the cathode channels cross the coolant channels associated with the anode channels. Accordingly, the use of mid-plane regions may be, and is, limited to the “non-active” manifold inlet and outlet regions 304, 306, rather than also existing in portions of the active region.

Although the disclosure has been described and illustrated with respect to the exemplary embodiments thereof, it should be understood by those skilled in the art that the foregoing and various other changes, omissions and additions may be made without departing from the spirit and scope of the disclosure. All such modifications and variations are intended to be included herein within the scope of this disclosure and protected by the accompanying claims.

What is claimed is:

1. A fuel cell stack (100) comprising:
a first fuel cell (102) having channels (116, 216, 316; 156, 256, 356) associated with an anode; and
a second fuel cell (101), located adjacent the first fuel cell, having channels (128, 228, 328; 158, 258, 358) associated with a cathode, the channels associated with the cathode exhibiting (344) directional independence with respect to the channels associated with the anode.

2. The fuel cell stack (100) of claim 1, wherein:
at least some the channels (116, 216, 316) associated with the anode are fuel channels operative to route fuel;
at least some of the channels (128, 228, 328) associated with the cathode are oxidant channels operative to route oxidant; and
at least some of the oxidant channels exhibit directional independence (344) with respect to the fuel channels.

3. The fuel cell stack (100) of claim 1, wherein:
at least some of the channels associated with both the anode and the cathode are coolant channels (156, 256, 356; 158, 258, 358) operative to route coolant; and
at least some of the coolant channels associated with the cathode (158, 258, 358) exhibit directional independence with respect to the coolant channels associated with the anode (156, 256, 356).

4. The fuel cell stack (100) of claim 1, wherein:
the first fuel cell further comprises a first active area in which the channels associated with the anode are located; and
the first active area lacks a mid-plane region.

5. The fuel cell stack (100) of claim 1, wherein:
the fuel cell stack further comprises a first plate (111, 211, 311), a second plate (121, 221, 321) and a third plate (150, 250, 350), with the third plate being positioned between the first plate and the second plate, the third plate having an anode side facing the first plate and an opposing cathode side facing the second plate;
the channels (116, 216, 316; 156, 256, 356) associated with the anode are located adjacent to the anode side of the third plate; and
the channels (128, 228, 328; 158, 258, 358) associated with the cathode are located adjacent to the cathode side of the third plate.

6. The fuel cell stack (100) of claim 5, wherein:
the first plate has a first rib (114, 214); and
the third plate (150, 250, 350) and the first rib define a coolant channel.

7. The fuel cell stack (100) of claim 1, wherein each of the first fuel cell (102) and the second fuel cell (101) is a Proton Exchange Membrane (PEM) fuel cell.

8. The fuel cell stack (100) of claim 1, further comprising:
an inlet manifold (304) having a mid-plane region and being operative to direct fluids to the channels associated with both the cathode and the anode; and
an outlet manifold (306) having a mid-plane region and being operative to direct fluids from the channels associated with both the cathode and the anode.

9. The fuel cell stack (100) of claim 1, wherein first portions of the channels associated with the anode are oriented parallel (342) to corresponding first portions of the channels associated with the cathode.

10. The fuel cell stack (100) of claim 1, wherein second portions of the channels associated with the anode cross (344) corresponding second portions of the channels associated with the cathode.

11. An assembly (152, 252, 300) for use in a fuel cell stack (100) comprising:
an active area (302) having a first plate (111, 211, 311), a second plate (121, 221, 321) and a third plate (150, 250, 350), with the third plate being positioned between the first plate and the second plate, the third plate having an anode side facing the first plate and an opposing cathode side facing the second plate;
the first plate defining fuel channels (116, 216, 316) on a side of the first plate facing away from the third plate and anode coolant channels (156, 256, 356) on a side of the first plate facing the third plate; and
the second plate defining oxidant channels (128, 228, 328) on a side of the second plate facing away from the third plate and cathode coolant channels (158, 258, 358) on a side of the second plate facing the third plate.

12. The assembly (300) of claim 11, wherein:
the first plate has ribs (114, 214); and
each of the fuel channels (116, 216, 316) is located between a corresponding adjacent pair of the ribs.

13. The assembly (300) of claim 12, wherein the anode coolant channels (156, 256, 356) are defined between the third plate and the corresponding undersides of the ribs.

14. The assembly (300) of claim 12, wherein:
the second plate has ribs (124); and
each of the oxidant channels (128, 228, 328) is located between a corresponding adjacent pair of the ribs of the second plate; and
the cathode coolant channels (158, 258, 358) are defined between the third plate and the corresponding undersides of the ribs of the second plate.

15. The assembly (300) of claim 11, wherein the first plate and the second plate are stamped plates.

16. The assembly (300) of claim 11, wherein at least some of the channels defined, at least partially, by the first plate exhibit directional independence (344) with respect to at least some of the channels defined, at least in part, by the second plate.

17. The assembly (300) of claim 11, wherein the active area (302) lacks a mid-plane region operative to enable turning of fluids within the active area.

18. The assembly (300) of claim 17, further comprising:
an inlet manifold (304) having a mid-plane region and being operative to direct fluids to the active area (302); and
an outlet manifold (306) having a mid-plane region and being operative to direct fluids from the active area (302).

19. The assembly (300) of claim 18, wherein:
the first plate has ribs (114, 214), and each of the fuel channels (116, 216, 316) is located between a corresponding adjacent pair of the ribs and the anode coolant channels (156, 256, 356) are defined between the third plate and the corresponding undersides of the ribs:
the second plate has ribs (124), and each of the oxidant channels (128, 228, 328) is located between a corresponding adjacent pair of the ribs of the second plate and the cathode coolant channels (158, 258, 358) are defined between the third plate and the corresponding undersides of the ribs of the second plate; and
the mid-plane regions in both the inlet manifold (304) and the outlet manifold (306) comprises both of the first and the second-plates lacking the ribs thereat, the third plate being absent thereat, and one of the first and the second plates being formed and positioned thereat substantially in a plane that is an extension of the third plate and including discrete bosses (364, 364′) extending to opposite sides of said one of the first and second plates to allow fluid flow there around.

20. The assembly (300) of claim 11, wherein:
first portions of the channels defined, at least partially, by the first plate are oriented parallel (342) to corresponding first portions of the channels defined, at least partially, by the second plate, and
second portions of the channels defined, at least partly, by the first plate are oriented (344) other than parallel to corresponding second portions of the channels defined, at least partially, by the second plate.
